(19) United States
(12) Patent Application Publication
(10) Pub. No.: US 2004/0160711 A1
(43) Pub. Date: Aug. 19, 2004

(54) Methods for delivering continuous electrical power offering physical and dielecrtic isolation

(76) Inventor: Walter William Stumberger, Hightstown, NJ (US)

Correspondence Address: Walter W. Stumberger, 203 Dutch Neck Road, Hightstown, NJ, 08520, US

(21) Appl. No.: 10/776,102

(22) Filed: Feb. 12, 2004

Related U.S. Application Data
(63) Continuation-in-part of application No. 10/094,769, filed on Mar. 11, 2002, now abandoned.

(51) Int. Cl. H02H 7/06

(52) U.S. Cl. 361/20

(57) ABSTRACT

The Method of this invention separates input power systems, typically a public power grid, from output electrical power, typically for use by electrically sensitive equipment, by converting the input energy into mechanical energy, transferring that mechanical energy, by way of a dielectric transfer medium, through a dielectric conduit structure, to a protected system at some desired distance which converts the mechanical energy back into useable and protected electrical power.

This is a continuation-in-part of the co-pending application Ser. No. 10/094,769 filed Mar. 3, 2002 and now abandoned.

### BACKGROUND OF THE INVENTION

The proliferation of Electromagnetic Pulse (EMP) Weapons, Flux Compression Generators (E-Bombs), Compton Effect Generators and other high-energy, high frequency, electrical and electromagnetic weapons place critical electronically sensitive infrastructures at risk. High-energy, high frequency, electrical arcs of 100 meters and more have been demonstrated. These localized power surges easily pass through power distribution systems to the sensitive end-point equipment both by way of the electrical wires that distribute the electricity throughout a given facility and the physical plant, which is usually made out of electrically conductive materials.

The methods of this invention provides safe, reliable and continuous electrical power to electrically sensitive equipment while maintaining the integrity and effectiveness of the protective structures that usually surround electrically sensitive infrastructures and thereby helps to eliminate one of the weakest parts of today's electronic infrastructure.

By converting external electrical energy into mechanical energy, and then transferring that mechanical energy through a dielectric system, this invention helps prevent the transmission of electrical and electromagnetic surges by physically and electro-magnetically isolating the public power grid from the protected power system through physical distance as well as electrical and electromagnetic insulation.

For the purposes of this Specification, the term “dielectric” relies on its full scientific definition and includes resistance to energy transfer over any and all parts of the electromagnetic spectrum. As found in this Specification the term “Air” requires special clarification and definition. Ambient air at normal room pressure, normal room temperature, and at rest, is neither an appreciable conductor nor an appreciable inhibitor of electricity. In the field of Dielectric Science, Air enjoys a special status and is given a Dielectric Coefficient of 1. As such, air does not appreciably participate in electrical calculations or in electrical fact. Air, which is agitated or compressed or heated, however does become more electrically conductive. Air is virtually transparent to electromagnetic propagation. Therefore, as applied to this Specification “Dielectric” is considered to be any substance or material that inhibits the propagation of electricity or electromagnetic waves more than ambient air.

This invention relates to the fields of electricity generation, electrical energy transmission, electrical insulation, electromagnetic insulation, and power system surge protection.

### SOME PRIOR ART

In U.S. Pat. No. 3,953,787, Helbling reveals a hydraulic system designed to provide an electrical step down process. This process requires the input of high-voltage electrical energy, which is converted into hydraulic energy for distribution across one or more energy converting systems that produce lower voltage electricity in direct proportion to the mechanical energy received.

In U.S. Pat. No. 5,289,106, McGinn describes a certified electrical appliance for driving low power electrical devices such as florescent lights in the most highly explosive and hazardous environments. This certified appliance accepts input energy from a wide range of sources and transfers that energy, by way of conductive pipes and slightly ionized air, to remote generators. Because this system eliminates all the electrical wiring, junction boxes and electrical conduits in the hazardous environment, it uses the conductive distribution system itself to drain off any dangerous static electric charges that might develop in the remote electromechanical sub-systems.

### BRIEF SUMMARY OF THE INVENTION

This invention continuously converts the source electricity, or other provided power, into a mechanical force, which is applied to a dielectric transfer medium. The dielectric transfer medium moves through dielectric conduits to remote conversion system as mechanical energy. The remote conversion system changes the mechanical force back into electrical energy.

By converting the initial energy into mechanical energy, this invention helps prevent the transmission of unwanted electrical and electromagnetic surges by physically and dielectrically isolating the external power source, and the external power source's associated hardware, from the internal power system through physical distance and dielectric insulation.

Since the internal energy converter can be located inside a protective shield or protected building, at some convenient distance from the input system, it can supply isolated, protected, and conditioned, electrical power on a continuous basis.

### BRIEF DESCRIPTIONS OF THE DRAWINGS

This specification is not limited to the embodiments disclosed herein but includes all possible variations of embodiments. Although turbine style torque converters are shown in all drawings, for simplicity, other types of torque converters are still within the scope of this Specification.

FIG. 1 shows a single input and single output configuration for this Method. Electric power source (1) drives electric motor (2) applying rotational force to torque converter (3). Torque converter (3) changes the rotational force from electric motor (2) into mechanical energy that is applied to a dielectric transfer medium (4) which is carried through the dielectric conduit (5) to torque converter (6). Torque converter (6) converts the mechanical energy of the dielectric transfer medium (4) into rotational force that drives generator (7). Generator (7) supplies electrical power for load (8). Dielectric conduit (9) returns the dielectric medium (4) to the torque converter.

Attachment point (101) can be used for the connection of an auxiliary power input source device. Attachment point (102) can be used for an auxiliary power output device.

FIG. 2 is similar to FIG. 1 and has the addition of items 201 and 202 which are conduits of any type and allow for an extended physical relationship between the input and the output and still maintain dielectric isolation and insulation.

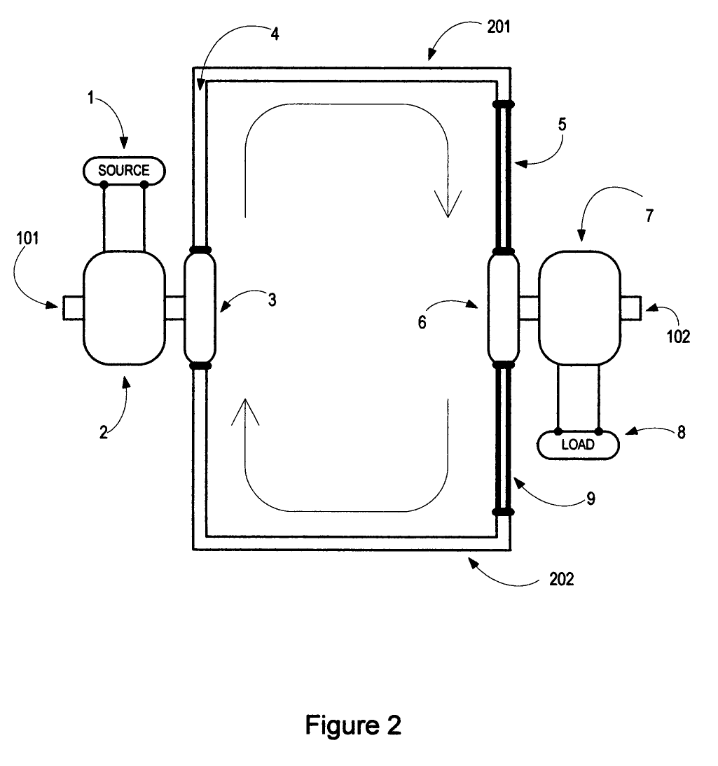

FIG. 3 shows the Method in a series output configuration offering physical isolation and dielectric insulation by adding additional equipment clusters shown as parts 5A, 6A, 7A, 8A, 9A and 102A.

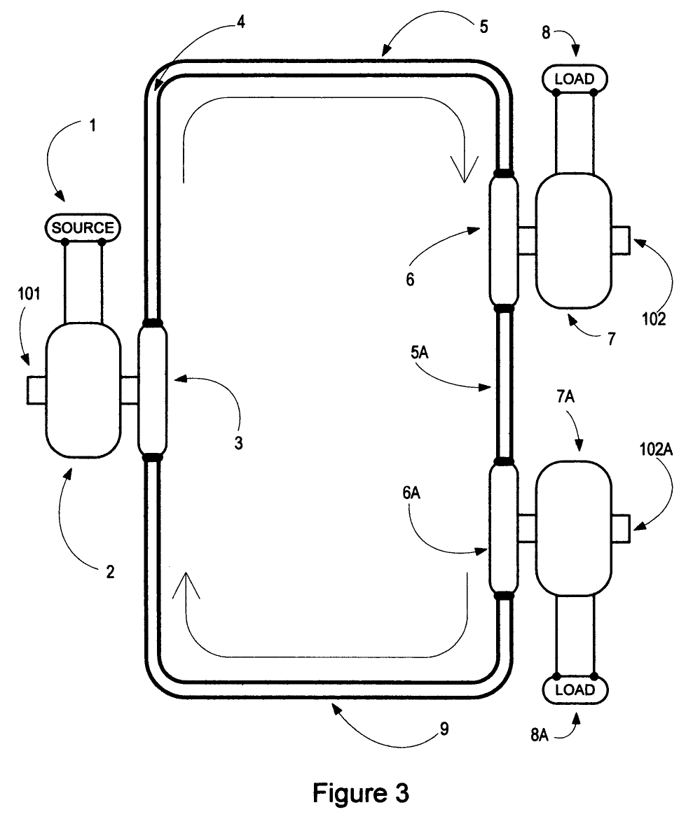

FIG. 4 shows the Method in a parallel output configuration offering physical isolation and dielectric insulation by adding additional equipment clusters shown as parts 5A, 6A, 7A, 8A, and 9A. In this configuration, conduits 201 and 202 are extended to accommodate additional equipment clusters not shown.

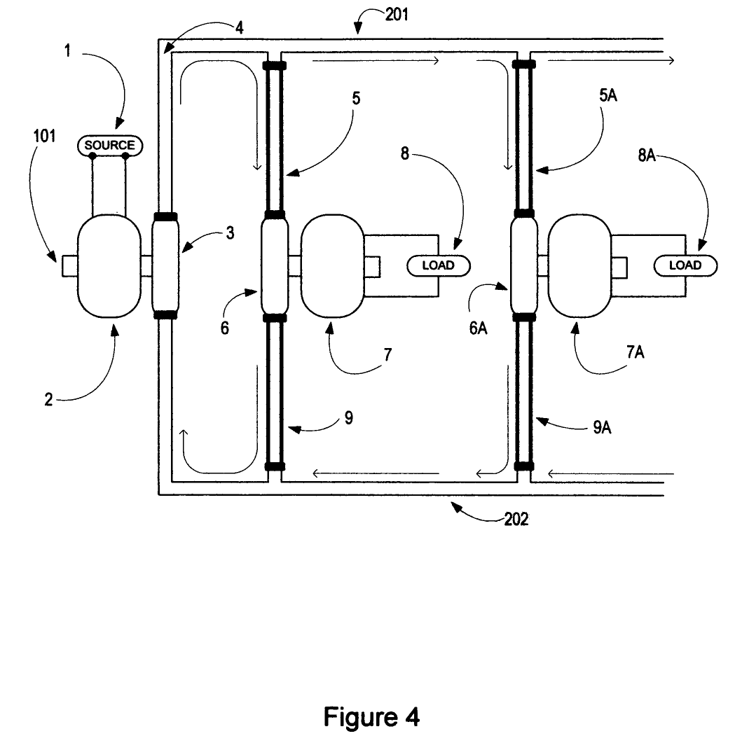

FIG. 5 shows a variation of FIG. 1. In this single input and single output configuration for this Method, electric power source (1) drives electric motor (2) applying rotational force to torque converter (3). Torque converter (3) changes the rotational force from electric motor (2) into mechanical energy that is applied to a dielectric transfer medium (4) which is carried through the dielectric conduits (9 and 9A) and non-dielectric conduit (202) from torque converter (6) creating a pressure differential. Air entering torque converter (6) converts the relative mechanical energy of the ambient air into dielectric transfer medium (4) creating a rotational force that drives generator (7). Generator (7) supplies electrical power for load (8).

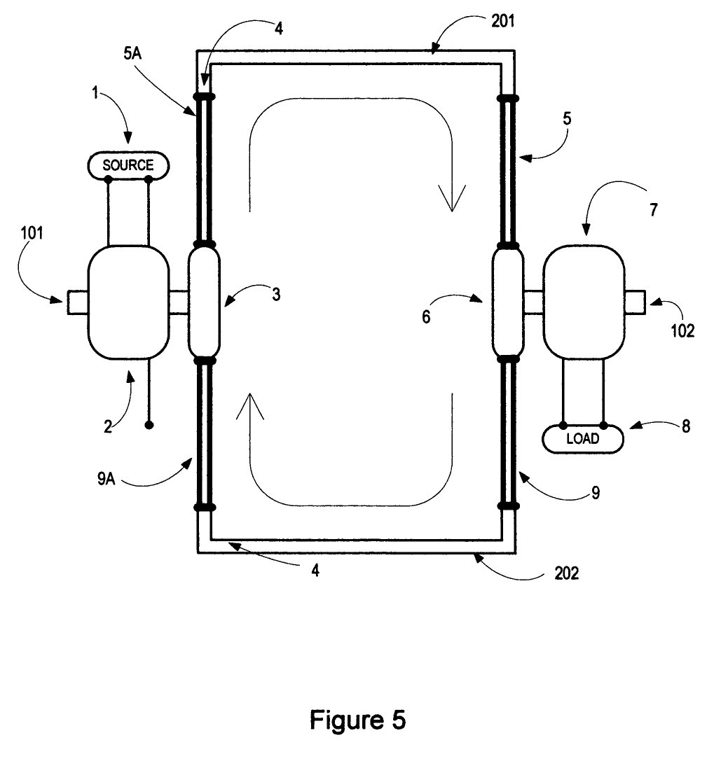

FIG. 6 shows a single input and single output configuration for this Method with one possible configuration of conveniently segmented multiple conduits that are dielectric and non-dielectric. Electric power source (1) drives electric motor (2) applying rotational force to torque converter (3). Torque converter (3) changes the rotational force from electric motor (2) into mechanical energy that is applied to a dielectric transfer medium (4) which is carried through the conveniently segmented dielectric conduit (5A) and the non-dielectric conduit (201) and the dielectric conduit (5) to torque converter (6). Torque converter (6) converts the mechanical energy of the dielectric transfer medium (4) into rotational force that drives generator (7). Generator (7) supplies electrical power for load (8). The conveniently segmented dielectric conduits (9 and 9A) and the non-dielectric conduit (202) and return the dielectric medium (4) to the torque converter.

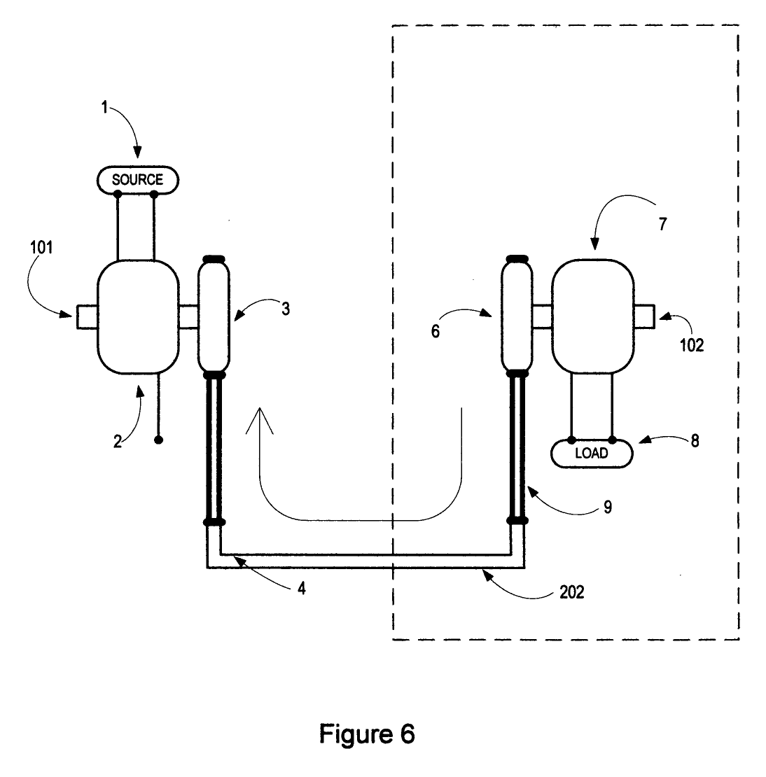

### DETAILED DESCRIPTION OF THE INVENTION

The Method uses a collection of mechanical and electrical components connected in such a way that energy from a Source (1) is delivered as electrical energy to Load (8) with sufficient dielectric insulation and physical separation so as to prevent any incoming electrical or electromechanical surges at the Source (1) from reaching and affecting Load (8).

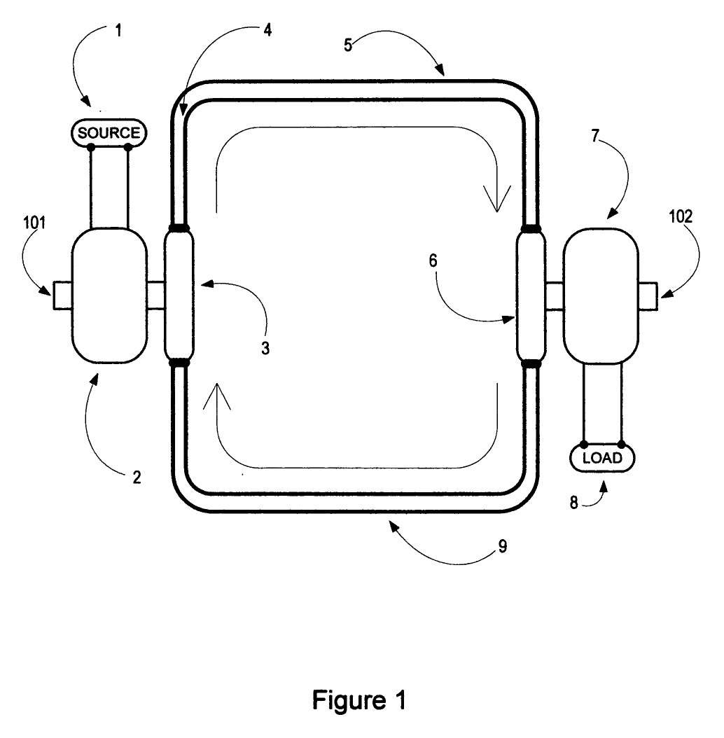

In one typical embodiment (see FIG. 1) electrical power from the Source (1) is applied to electric motor (2), which drives torque converter (3). Torque converter (3) impresses mechanical energy onto a dielectric energy transfer medium (4). Dielectric energy transfer medium (4) is carried through a dielectric conduit (5) to torque converter (6). Torque converter (6) converts the mechanical energy of the dielectric energy transfer medium (4) into rotational energy to drive generator (7). Generator (7) provides electrical power to the Load (8). After leaving torque converter (6) the dielectric energy transfer medium (4) is carried back to torque converter (3) through dielectric conduit (9).

Alternative devices such as an internal combustion engines, or a turbine engines, or other devices, can be attached to the input system in any combination.

The system can be configured with a plurality of serial or parallel inputs and a plurality of serial or parallel outputs, using a plurality of equipment clusters, so long as dielectric insulation and convenient physical isolation is maintained.

While this illustrates and describes what are at present considered to be preferred embodiments of the present invention it will be understood by those skilled in the art that various changes and modifications may be made, and equivalents may be substituted for elements thereof without departing from the true scope of the present invention. In addition, many modifications may be made to adapt a particular situation or material to the teaching of this invention without departing from the central scope of this invention. Therefore, it is intended that the present invention not be limited to the particular embodiment disclosed as the best mode contemplated for carrying out the present invention, but that the present invention includes all embodiments falling within the scope of the appended claims.

From the foregoing, it will be appreciated by those skilled in the art that the present invention provides a particularly effective and advantageous method of and apparatus for overcoming many of the limitations associated with connecting electrical Loads (8) with electrical Sources (1) in close electrical proximity. It will also be readily appreciated by one with ordinary skill in the art to use the method and apparatus of the present invention in other configurations. Although certain presently preferred embodiments of the present invention have been specifically described herein, it will be apparent to those skilled in the art to which the invention pertains that variations and modifications of the various embodiments shown and described herein may be made without departing from the spirit and scope of the invention

The attached descriptions and drawings and claims are regarded by the applicant as including a variety of individually inventive concepts, some of which may lie partially or wholly outside the scope of some or all of the claims. The fact that the applicant has chosen, at the time of filing of the present application, to restrict the claimed scope of protection in accordance with the attached claims is not to be taken as a disclaimer for alternative inventive concepts that are included in the contents of the application and could be defined by claims differing in scope from the attached claims, which different claims may be adopted at some later time.

1. Claim 1 is a method for continuous distribution of electrical energy offering physical isolation and dielectric insulation between input power sources and output power loads wherein
energy from an input device or a plurality of input devices is applied to a torque converter or a plurality of torque converters which continuously move a dielectric transfer medium
with said dielectric transfer medium traveling through a dielectric conduit or a plurality of dielectric conduits connected to a remote torque converter or plurality of remote torque converters and
with said remote torque converters being attached to an electrical generating device or a plurality of electrical generating devices each providing electrical power.

2. Claim 2 is a method for continuous distribution of electrical energy offering physical isolation and dielectric insulation between input power sources and output power loads wherein
energy from an input device or a plurality of input devices is applied to a torque converter or a plurality of torque converters which continuously move a dielectric transfer medium
with said dielectric transfer medium traveling through convenient segments of dielectric and non-dielectric conduits or a plurality of convenient segments of dielectric and non-dielectric conduits connected to a remote torque converter or plurality of remote torque converters and
with said remote torque converters being attached to an electrical generating device or a plurality of electrical generating devices each providing electrical power.

3. Claim 3 is a method for continuous distribution of electrical energy offering physical isolation and dielectric insulation between input power sources and output power loads wherein
energy from an input device or a plurality of input devices is applied to a torque converter or a plurality of torque converters which continuously create low pressure environments inside convenient segments of dielectric and non-dielectric conduits or a plurality of convenient segments of dielectric and non-dielectric conduits
with said low pressure environment attracting ambient air from a dielectrically protected enclosure through a remote torque converter or plurality of remote torque converters and
with said remote torque converters being attached to an electrical generating device or a plurality of electrical generating devices each providing electrical power.
